(19) United States
(12) Patent Application Publication
(10) Pub. No.: US 2010/0302899 A1
(43) Pub. Date: Dec. 2, 2010

(54) MATERIAL HANDLING APPARATUS, SYSTEM, AND METHOD

(76) Inventors: Daniel L. Dermody, Midland, MI (US); Andrew S. Zalusky, Midland, MI (US)

Correspondence Address: The Dow Chemical Company, P.O. BOX 1967, Midland, MI, 48641, US

(21) Appl. No.: 12/472,030

(22) Filed: May 26, 2009

(51) Int. Cl. B01F 13/08

(52) U.S. Cl. 366/337

(57) ABSTRACT

The present invention generally relates to a material handling apparatus and system comprising same and method of using the material handling apparatus for moving a flowable material, preferably mixing two or more flowable materials together. The present invention generally relates to moving or mixing flowable material(s) by simultaneously applying two orthogonally-oriented motive forces to the flowable material(s) disposed in a container.

### BACKGROUND OF THE INVENTION

1. Field of the Invention

The present invention generally relates to a material handling apparatus and system comprising same and method of using the material handling apparatus for mixing materials together.

2. Description of the Related Art

Examples of mixing devices are a device for producing a movable magnetic field, rocker, rotating mixer, gas bubbler, vibrator, shaker including an orbital shaker, and vortexer. Research Products International Corporation (Mount Prospect, Ill., USA) sells LAB QUAKE® Rotating Micro-Tube Mixers under order numbers 400110 and 415110. U.S. Pat. No. 6,176,609 B1 mentions a mixing device and method for simultaneously stirring thousands of vessels or wells of microplates. U.S. Pat. No. 6,357,907 B1 mentions a mixing device and method for simultaneously stirring and aerating thousands of vessels or wells of microplates.

A spinning or tumbling magnetic stir element (e.g., magnetic stir bar, dowel, disc, or ball) that would be positioned within a medium viscosity liquid (e.g., a viscosity from 200 centipoise (cP) to less than 20,000 cP at 20° C. (° C.)) or high viscosity liquid (e.g., a viscosity from 20,000 cP to as high as 100,000 cP at 20° C.) cannot create a vortex in the medium or high viscosity liquid and pull down another material disposed above it into the medium or high viscosity liquid. The magnetic stir elements would move only the portion of the medium or high viscosity liquid that falls within a volume defined by the magnetic stir element when it is spun or tumbled.

Chemical industry desires a material handling apparatus and method that would be capable of, among other things, mixing a viscous and non-viscous material together within a sealed container. Preferably, a laboratory-scale version of the material handling apparatus would be useful in a system for and the mixing method comprises a high throughput mixing workflow. Such high throughput mixing workflow would be especially useful as a means for accelerating materials and formulations research and development.

### BRIEF SUMMARY OF THE INVENTION

In a first embodiment, the present invention is a material handling apparatus comprising a container defining an enclosed volumetric space and a means for simultaneously applying two motive forces within the enclosed volumetric space of the container, wherein the means for simultaneously applying two motive forces within the enclosed volumetric space of the container is in motive force communication with the enclosed volumetric space of the container and each of the two motive forces independently is characterizable as having a force direction and the force direction of one of the two motive forces is oriented approximately orthogonally (i.e., approximately perpendicularly at a point of intersection) to the force direction of the other of the two motive forces. Preferably, the material handling apparatus further comprises a container sealing means, the container sealing means being in sealing operative contact to the container so as to seal the container and thereby prevent fluid communication between the enclosed volumetric space of the container and a space outside of the container.

In a second embodiment, the present invention is a method of simultaneously moving different portions of a flowable material in a container in two approximately orthogonal directions, the method comprising a step of simultaneously applying two motive forces to a flowable material that is disposed in an enclosed volumetric space of a container, wherein each motive force independently is characterized as having a force direction and the force direction of one of the motive forces is oriented approximately orthogonally to the force direction of the other of the motive forces, thereby simultaneously moving different portions of the flowable material in two approximately orthogonal directions in the enclosed volumetric space of the container.

In a third embodiment, the present invention is a high throughput workflow system comprising a high throughput material handling apparatus, the high throughput material handling apparatus comprising a plurality of containers and a means for simultaneously applying two motive forces within the enclosed volumetric spaces of each of the plurality of containers, wherein the means for simultaneously applying two motive forces within the enclosed volumetric spaces of the plurality of containers is in motive force communication with each of the enclosed volumetric spaces of the containers and each of the two motive forces independently is characterizable as having a force direction and the force direction of one of the two motive forces is oriented approximately orthogonally to the force direction of the other of the two motive forces.

The material handling apparatus of the first embodiment and system of the third embodiment are independently useful in the method of the second embodiment. In the method of the second embodiment, each container independently holds one or more flowable materials. The material handling apparatus of the first embodiment and system of the third embodiment and method of the second embodiment are useful in any procedure, process, or method that could benefit from a simultaneous application of two orthogonally-directed motive forces to the flowable material(s). Such procedure, process, or method includes industrial-scale manufacturing, pilot plant-scale development, and laboratory-scale research settings. The embodiments are especially for moving a flowable material that is characterizable as having a high viscosity liquid (e.g., a high viscosity solution for crystallization of a solute therefrom) and mixing two or more flowable materials together, wherein at least one of the flowable materials is a liquid characterizable as having a medium or high viscosity liquid or is a particulate solid.

The material handling apparatus of the first embodiment and system of the third embodiment and method of mixing of the second embodiment are useful in any application that could benefit from the aforementioned procedure, process, or method comprising simultaneous application of two orthogonally-directed motive forces to the one or more flowable materials. The embodiments are especially useful in applications for preparing, for example, formulation samples such as flowable liquid-liquid formulations, particulate solid dispersions in a liquid, colloids, solutions of solutes dissolved in solvents characterized by a concentration gradient of solutes therein, microgels, and dispersions or solutions of a gas in a liquid. The system of the third embodiment is particularly useful in a high throughput mixing workflow. Such high throughput mixing workflow is especially useful as a means for accelerating materials and formulations research and development in, for example, the combinatorial chemistry, in vitro biological assay, coating (e.g., paint), cleaner formulation, polymer latex, and polymer-microfiller and -nanofiller composite arts.

Additional embodiments are described in accompanying drawing(s) and the remainder of the specification, including the claims.

### BRIEF DESCRIPTION OF THE DRAWING(S)

Some embodiments of the present invention are described herein in relation to the accompanying drawing(s), which will at least assist in illustrating various features of the embodiments.

FIG. 1 (FIG. 1) shows a perspective view of a preferred embodiment of the material handling apparatus of the first embodiment.

FIG. 2 shows the perspective view of the preferred embodiment of FIG. 1 except with section line 2-2 added and without most of the reference lines and numbers shown in FIG. 1.

FIGS. 3A to 3E show a time series of sequential section orthogonal views of the preferred embodiment that is shown in FIGS. 1 and 2 from the viewpoint indicated by section line 2-2 of FIG. 2.

FIG. 4 shows a partial section, perspective view of another preferred embodiment of the material handling apparatus of the first embodiment.

FIG. 5A shows two periodically orthogonal force directions placed within x,y,z coordinates.

FIG. 5B shows two essentially continuously orthogonal force directions placed within x,y,z coordinates.

### DETAILED DESCRIPTION OF THE INVENTION

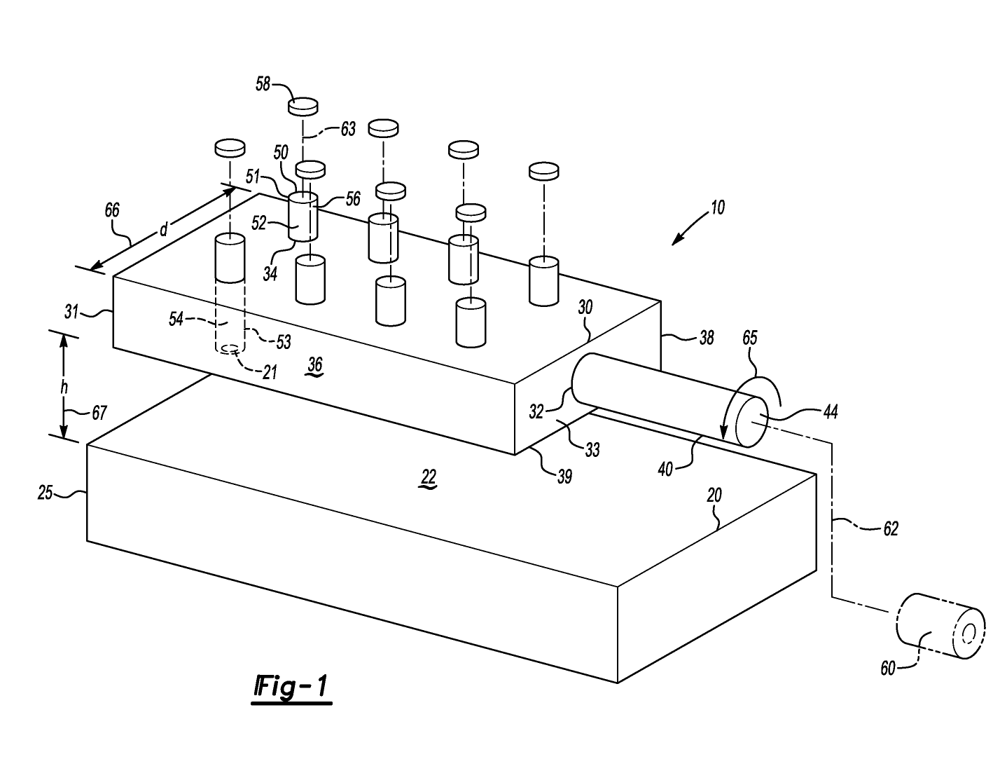

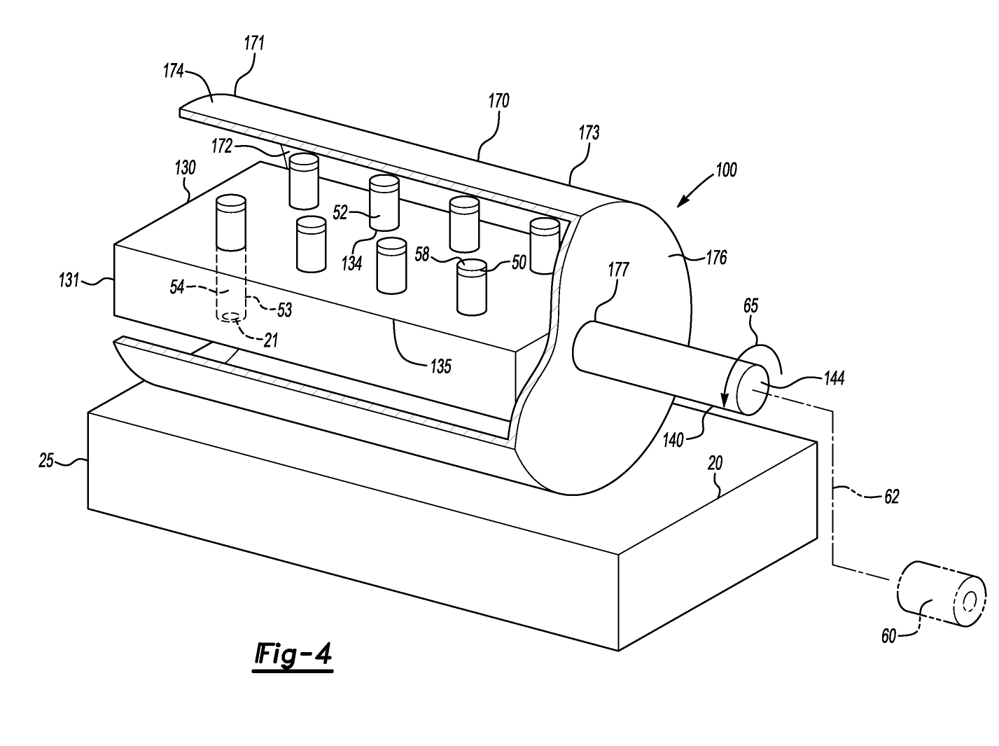

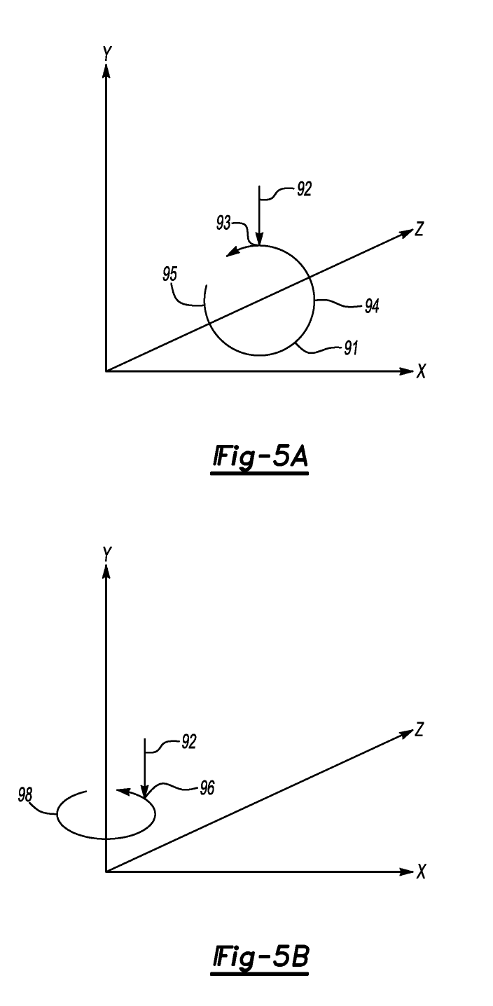

FIG. 1 shows a perspective view of a preferred embodiment of the material handling apparatus of the first embodiment, which preferred embodiment is material handling apparatus 10 (other embodiments of the material handling apparatus of the first embodiment are contemplated). Material handling apparatus 10 comprises magnetic stirrer 20, magnetic stir elements 21 (one shown by hidden line as a magnetic stir bar but could be any shape), container holder 30, shaft 40, and containers 50. Also, shown in FIG. 1 for illustrative purposes are a plurality of container sealing means 58, a means for rotating 60, and direction arrow 65, which indicates a possible direction of rotation of shaft 40 and, thus, of container holder 30, around a horizontal x-axis (e.g., see FIGS. 5A and 5B).

Magnetic stirrer 20 defines top surface 22, left face 25, and at least one driver magnet (not shown; e.g., bar driver magnet). The driver magnet(s) (not shown) of magnetic stirrer 20 produces a magnetic field(s) (not shown). Preferably, the magnetic field(s) is movable, and more preferably rotatable, the rotatable magnetic field(s) still more preferably being either rotatable about a z-axis in a vertical x-y plane (e.g., see FIG. 5A), such as when magnetic stirrer 20 comprises a magnetic tumble stirrer, or rotatable about a y-axis in a horizontal x-z plane (e.g., see FIG. 5B), such as when magnetic stirrer 20 comprises a conventional magnetic stir plate.

Container holder 30 comprises a non-magnetic material and defines spaced-apart container receiving apertures 34, spaced-apart and opposing left face 31 and right face 33, spaced-apart and opposing front face 36 and rear face 38 (not shown), and bottom surface 39 (not shown). Container holder 30 defines shaft receiving aperture 32 in right face 33. Shaft receiving aperture 32 is characterized by a center point (not shown). Front and rear faces 36 and 38 (not shown) are spaced apart by distance d 66 and shaft receiving aperture 32 is disposed in container holder 30 approximately equidistant between front and rear faces 36 and 38 (not shown) such that a center point (not shown) of shaft receiving aperture 32 is approximately 0.5 d from each of front and rear faces 36 and 38 (not shown).

Shaft 40 has spaced-apart and opposing holder-receiving end (not shown) and drive element engaging end 44. Drive element engaging end 44 of shaft 40 is in driving operative connection to means for rotating 60 via projected line 62. Shaft 40 and means for rotating 60 are not drawn to the same scale.

Each container 50 comprises a non-magnetic material and defines an open end 51 and enclosed volumetric space 52 therein, the enclosed volumetric space 52 having a bottom portion 54 (shown by hidden line 53 for one container 50) and a top portion 56, which is in fluid communication with bottom portion 54. Open end 51 of each container 50 is in sealing operative contact with a different one of container sealing means 58, each of which is indicated to be in said sealing operative contact with said open end 51 of container 50 by projected lines 63. The sealing operative contact prevents fluid communication between enclosed volumetric space 52 of container 50 and a space outside of container 50. Examples of the space outside of container 50 are container holder 30 and an exterior surface (not indicated) of container 50.

Means for rotating 60 preferably is a commercially available, variable speed electric stirrer motor.

Assemble material handling apparatus 10 by disposing containers 50 in container receiving apertures 34 of container holder 30 so as to establish reversible securing operative contact therebetween. Securely dispose holder receiving end (not shown) of shaft 40 within shaft receiving aperture 32 of container holder 30. Engage drive element engaging end 44 of shaft 40 in rotatable operative contact with a means for rotating 60, which also functions to hold container holder 30 and shaft 40 above a supporting surface (not shown, e.g., a laboratory bench top). Dispose magnetic stirrer 20 on a supporting surface (not shown, e.g., a laboratory bench top) and below and spaced-apart from bottom surface 39 (not shown) of container holder 30. Magnetic stirrer 20 is so disposed such that top surface 22 thereof is spaced apart from bottom surface 39 (not shown) of container holder 30 by distance h 67 so as to establish magnetic field communication between the magnetic field (not shown) produced by the driver magnet(s) (not shown) of magnetic stirrer 20 and at least bottom portions 54 of enclosed volumetric spaces 52 of containers 50, while providing sufficient space between container holder 30 and magnetic stirrer 20 so as to allow container holder 30 to be rotated above magnetic stirrer 20 without physically contacting magnetic stirrer 20. Thus is assembled material handling apparatus 10.

Before operating material handling apparatus 10 in the method of the second embodiment, first make preparations for moving a single flowable material (e.g., for moving a solution comprising a solute dissolved in a solvent, the solute thereby being allowed to crystallize from the moving solution) or for mixing two or more flowable materials together, or a combination thereof in different containers. As part of such preparations, independently provide one or more, preferably two or more, and more preferably eight containers 50; at least one, preferably two or more different flowable materials for each container 50; one magnetic stir element 21 for each container 50; and one container sealing means 58 for each container 50. (Alternatively, instead of using one container sealing means 58 for each container 50, a single container sealing means (e.g., a rubber dam; not shown) can be used to simultaneously seal a plurality of containers 50, each one of the plurality of containers 50 being in sealing operative contact with a different portion of the single container sealing means (not shown).) Each magnetic stir element 21 is characterizable as producing a magnetic field. Dispose one of the magnetic stir elements 21 and either at least one flowable material (not shown) or two or more different flowable materials (not shown) within enclosed volumetric space 52 of a different one of containers 50. Seal each container 50 with a different one of the container sealing means 58 by disposing the container sealing means 58 in sealing operative contact to a different one of containers 50 proximal to open ends 51 thereof. Containers 50 are thus sealed so as to prevent fluid communication between their enclosed volumetric spaces 52 and spaces outside of containers 50 (e.g., container holder 30) via open ends 51 thereof. Each of containers 50 having the flowable materials (not shown) and magnetic stir element 21 disposed therein and being sealed with one of the container sealing means 58 will preferably have a headspace (not shown, i.e., an unfilled portion of enclosed volumetric space 52) that comprises at least a part of upper portion 56 of enclosed volumetric space 52 of each container 50. If not already done, dispose different ones of containers 50 sealed with container sealing means 58 in different ones of container receiving apertures 34 of container holder 30 of material handling apparatus 10 so as to establish reversible securing operative contact between each of containers 50 sealed with container sealing means 58 and container holder 30 within one of container receiving apertures 34 and to independently establish magnetic field communication between the magnetic field (not indicated) produced by the driver magnet(s) (not shown) of magnetic stirrer 20 and magnetic fields (not shown) produced by magnetic stir elements 21. The magnetic fields (not shown) produced by magnetic stir elements 21 disposed in containers 50 in container holder 30 are sufficiently spaced apart from each other so to not unacceptably interfere with each other during the method of the second embodiment. Thus, the material handling apparatus 10 is prepared for performing a method of the second embodiment.

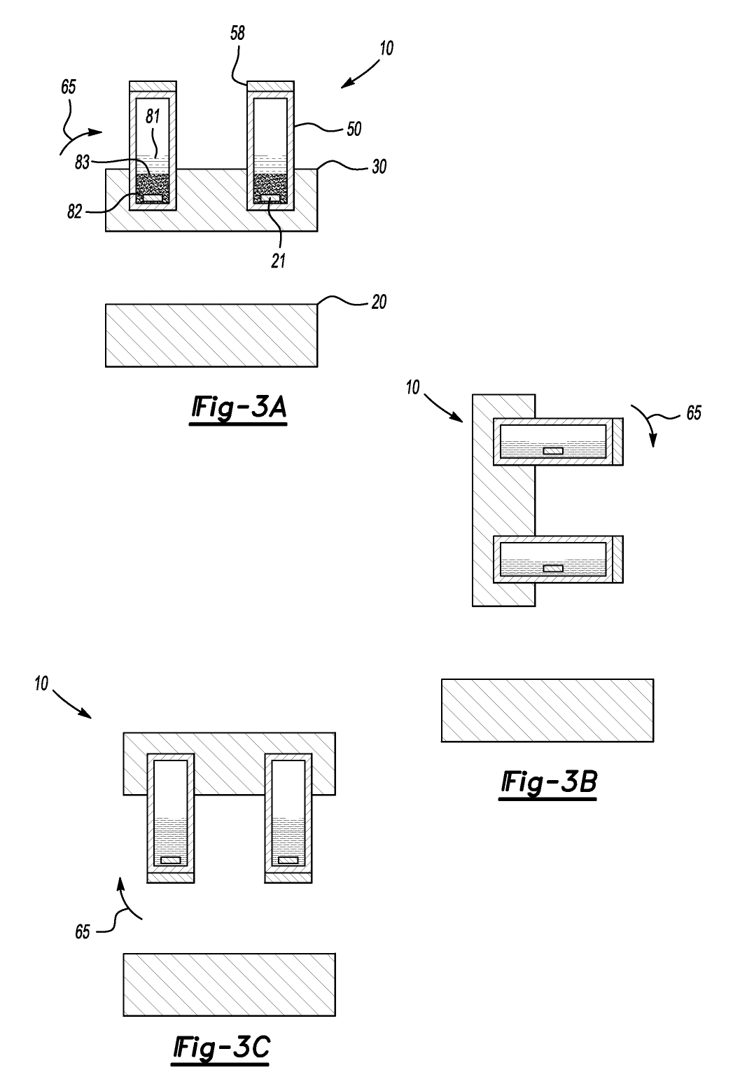

In some embodiments, perform the method of the second embodiment employing material handling apparatus 10 as described in this paragraph. (Other ways of performing the mixing method of the second embodiment with material handling apparatus 10 are contemplated.) Initiate the method of the second embodiment employing material handling apparatus 10 by activating the driver magnet(s) (not shown) of magnetic stirrer 20 so as to establish directional movement of the magnetic field(s) (not shown) produced thereby. In some embodiments, directional movement, preferably rotating of the magnetic field(s) (not shown) of the driver magnet(s) (not shown) of magnetic stirrer 20 will then establish corresponding directional movement of magnetic stir elements 21 within containers 50. Preferably, the directional movement of magnetic stir elements 21 comprises rotation such as spinning about a y-axis (FIG. 5B) or tumbling about a z-axis (FIG. 5A) as described herein. In other embodiments, corresponding directional movement of magnetic stir elements 21 within containers 50 will not be so established at this stage of the method such as where, for example, at least one flowable material is a medium or high viscosity liquid or dense particulate solid that inhibits such directional movement of one or more of the magnetic stir elements 21. In such other embodiments, the directional movement of the magnetic stir elements 21 will be established at a later stage of the method, for example after shaft 40 begins rotating, as described below. Activate the means for rotating 60 so as to establish rotation of shaft 40 and container holder 30 in the circular direction indicated by arrow 65. After initiation of such rotation of shaft 40 and container holder 30, then any inhibition of directional movement, preferably spinning or tumbling, of the magnetic stir elements 21 described earlier for the other embodiments will be overcome and directional movement of the magnetic stir elements 21 will be established within enclosed volumetric spaces 52 of containers 50. Thus are respectively established simultaneous horizontal x-z plane (see spinning in FIG. 5B) and vertical x-y plane (see falling in FIG. 5B) directional movements of magnetic stir element 21 or simultaneous horizontal x-y plane (see tumbling in FIG. 5A) and vertical x-y plane (see falling FIG. 5A) directional movements of magnetic stir element 21. The x-z plane is orthogonal to the x-y plane. Falling of magnetic stir element 21 in the x-y plane (e.g., 92 in FIGS. 5A and 5B) provides a first motive force, the first motive force being in the x-y plane. Spinning of magnetic stir element 21 in the x-z plane provides a second motive force, the second motive force being in the x-z plane at any point around the y-axis (see FIG. 5B). Alternatively, tumbling of magnetic stir element 21 in a vertical x-y plane provides a different second motive force and a third motive force, the different second motive force being in the x-y plane (e.g., at 91 in FIG. 5A) and the third motive force (e.g., at 93 in FIG. 5A) being in the x-z plane. The first and second motive forces are orthogonal to each other. The first and third motive forces are orthogonal to each other. The first and second motive forces, or first and third motive forces as the case may be, simultaneously act upon either different portions of the single flowable material or a first portion of one of the two or more flowable materials and a second portion of another of the two or more flowable materials, the first and second portions thus being different, in a same container 50, thereby respectively moving the single flowable material, or mixing the two or more flowable materials together to form an approximately uniform mixture thereof, in the same container 50 according to the method of the second embodiment. Such falling directional movements are described in more detail for FIGS. 3A to 3E later. Such tumbling or spinning directional movements are described in more detail for respective FIGS. 5A and 5B later. The rotating directional movements of magnetic stir elements 21 and shaft 40 preferably independently are elliptical, and more preferably circular. The vertical x-y plane directional movement is approximately linear as during rotation of shaft 40 and container holder 30, containers 50 are repeatedly inverted, and then returned upright (as shown in FIG. 1). Nonlinear vertical x-y plane directional movements are contemplated, e.g., where inner diameter (not indicated) of container 50 varies (e.g., when container 50 is vertically contoured). This repeated inverting and returning upright thereby establishes a back-and-forth-like movement of the flowable material(s) and magnetic stir element 21 between the bottom portion 54 and the top portion 56 and then back to the bottom portion 54 of enclosed volumetric space 52 of container 50 as the flowable material(s) and magnetic stir element 21 periodically fall downward within containers 50 under motive force of gravity. Thus, magnetic stir elements 21 and flowable material(s) will at times be moving in bottom portions 54, and at other times in top portions 56, and at still other times straddling bottom portions 54 and top portions 56, of enclosed volumetric spaces 52 of containers 50. The simultaneous rotating and falling directional movements of the flowable material(s) and magnetic stir element 21 in a same container 50 comprise an example of simultaneous application of two motive forces of gravity and a physical power characterized by a force vector tangential to circular motion of rotation of magnetic stir element 21 to the flowable material(s) in the same container 50, wherein each motive force is characterizable as having a force direction and the force direction of one of the motive forces (i.e., movement of magnetic stir element 21) is approximately orthogonally (i.e., approximately perpendicularly at a point of intersection) to the force direction of the other of the motive forces (i.e., gravity) (see FIGS. 5A and 5B). Thus is respectively established a simultaneously moving of different portions of the single flowable material, or moving the first portion of one of the two or more flowable materials and the second portion of another of the two or more flowable materials, in two approximately orthogonal directions according to the method of the second embodiment.

If desired during the method of the second embodiment, (a) adjust speed of the directional movement of the magnetic field(s) (not shown) of driver magnet(s) (not shown) of magnetic stirrer 20 such as by adjusting number of revolutions per minute of the driver magnet(s) (not shown) (e.g., by adjusting a speed dial (not shown) on magnetic stirrer 20); or (b) adjust speed of rotation of shaft 40 and container holder 30 such as by adjusting power output of the means for rotating 60 and, thus, number of revolutions per minute of rotation of shaft 40 and container holder 30; or adjust both (a) and (b), so as to establish optimal mixing of the flowable material(s) in each container 50 under the particular circumstances.

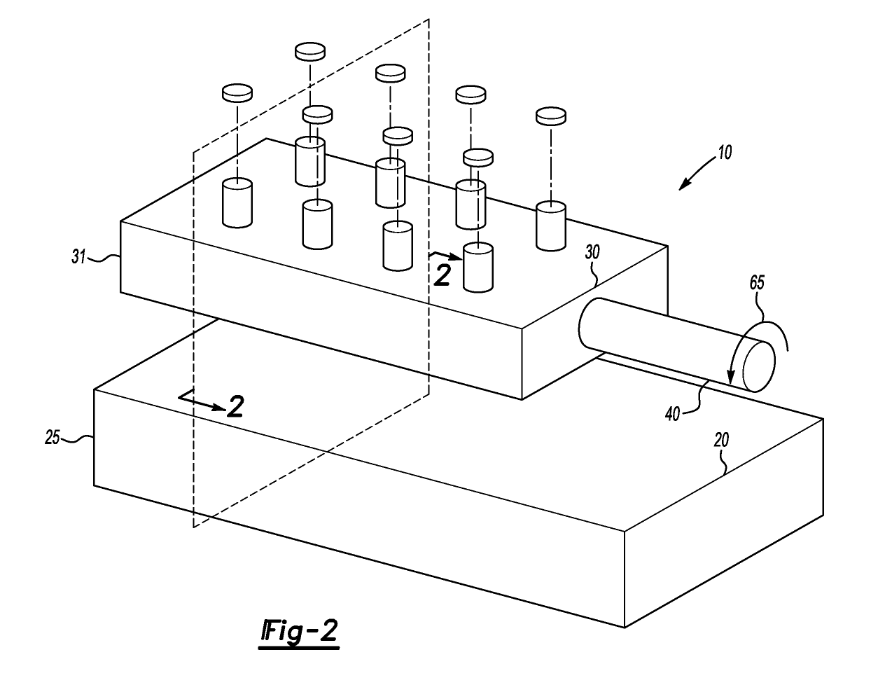

FIG. 2 shows the perspective view of the preferred embodiment of FIG. 1 except with section line 2-2 added and without most of the reference lines and numbers shown in FIG. 1. Section line 2-2 indicates the direction of view of the section orthogonal views of FIGS. 3A to 3E. In FIG. 2, the direction of view is left-to right, i.e., toward left face 31 of container holder 30 and left face 25 of magnetic stirrer 20. Direction arrow 65 indicates a possible direction of rotation of shaft 40 and, thus, of container holder 30, around a horizontal x-axis (e.g., see FIGS. 5A and 5B).

FIGS. 3A to 3E show a time series of sequential section orthogonal views of material handling apparatus 10 that is shown in FIGS. 1 and 2. The time series is shown from the viewpoint indicated by section line 2-2 of FIG. 2. FIGS. 3A to 3E each show a section orthogonal view of magnetic stirrer 20, container holder 30, two of containers 50, two of container sealing means 58, and two of magnetic stir elements 21 (drawn as a magnetic stir bar but could take any shape as described herein) of material handling apparatus 10. Also shown for illustration purposes in each of FIGS. 3A to 3E is arrow 65 (see also FIG. 1) indicating the circular direction of rotation of shaft 40 (see FIG. 2) and, thus, of container holder 30, the time series of orthogonal views during the rotation being shown sequentially in order from FIG. 3A to FIG. 3B to FIG. 3C to FIG. 3D to, and ending at, FIG. 3E. Also shown in FIGS. 3A to 3E for illustrative purposes are low viscosity flowable material 81 (indicated by dots ·) and high viscosity flowable material 82 (indicated by dashes -) in contact with each other along line 83. In FIG. 3A, which is a view before mixing, low viscosity flowable material 81 (e.g., viscosity of 20 cP at 20° C.) is disposed on top of, and has not mixed with, high viscosity flowable material 82 (e.g., viscosity of 6,000 cP at 20° C.).

For reasons analogous to those previously described herein (i.e., a magnetic stir element cannot create a vortex in a high viscosity liquid), simply rotating (i.e., spinning or tumbling) magnetic stir element 21 within high viscosity flowable material 82 would not cause mixing of same with low viscosity flowable material 81. Rather, to achieve such mixing, employ the method of the second embodiment as illustrated in FIGS. 3A to 3E. In FIG. 3A, activate the driver magnet(s) (not shown) of magnetic stirrer 20 as described previously for FIG. 1 to cause movement of magnetic field(s) produced thereby and, thus, movement, preferably rotation, of magnetic stir elements 21. Magnetic stir elements 21 thus rotate by either spinning in a horizontal x-z plane or tumbling in a vertical x-y plane in FIGS. 3A to 3E (see FIGS. 5A and 5B). (For clearer illustration of the rotation of shaft 40 and container holder 30, the spinning or tumbling of magnetic stir elements 21 within containers 50 is not indicated in FIGS. 3A to 3E.) Activate means for rotating 60 (see FIG. 1) so as to initiate clockwise rotation of shaft 40 (FIG. 2), and thus of container holder 30, as indicated by direction arrow 65. Container holder 30 begins to rotate and containers 50 thus begin to move in a circular motion in a vertical x-y plane, i.e., orthogonal to and simultaneous with the horizontal plane movement (e.g., rotation) of magnetic stir elements 21 (see FIGS. 5A and 5B). One quarter revolution of shaft 40 (FIG. 2) and container holder 30 gives a horizontal (x-axis; see FIGS. 5A and 5B), right-pointing orientation of containers 50 as shown in FIG. 3B. Continue viewing rotation of shaft 40 (FIG. 2) and container holder 30 after each one quarter revolution to sequentially give a vertical (y-axis; see FIGS. 5A and 5B), downward-pointing orientation of containers 50 as indicated in FIG. 3C; then a horizontal, left-pointing orientation of containers 50 as indicated in FIG. 3D; and, ultimately, a vertical, upward-pointing orientation of containers 50 as indicated in FIG. 3E. Mixing of high viscosity flowable material 82 with low viscosity flowable material 81 thereby begins between FIGS. 3A and 3B, and progresses from FIG. 3B to FIG. 3C to FIG. 3D, and ultimately to FIG. 3E. Continue the method of the second embodiment cycling from orientation shown in FIG. 3E back sequentially to those shown in FIGS. 3B, 3C, 3D, and 3E as many times as desired until high viscosity flowable material 82 and low viscosity flowable material 81 are mixed together to give an approximately uniform mixture thereof. If desired, (a) adjust speed of movement (e.g., rotation) of magnetic stir elements 21 by adjusting speed of movement (e.g., rotation) of driver magnet(s) (not shown) of magnetic stirrer 20; or (b) adjust speed of rotation of shaft 40 (FIG. 2) and thus container holder 30 by varying power output of means of rotating 60; or adjust speeds of both (a) and (b), all as described previously, to achieve optimal mixing under the particular conditions.

The method of the second embodiment is capable of producing the approximately uniform mixture in substantially less time than the time it would take to produce the approximately uniform mixture using just movement (e.g., rotation) of magnetic stir elements 21 alone or rotation of container holder 30 alone, but not both. In some embodiments, the method of the second embodiment is more than 2 times, preferably more than 5 times, more preferably more than 10 times, still more preferably more than 20 times, and even more preferably more than 50 times faster than the fastest mixing rate of either just movement (e.g., rotation) of magnetic stir elements 21 alone or movement (e.g., rotation) of container holder 30 alone.

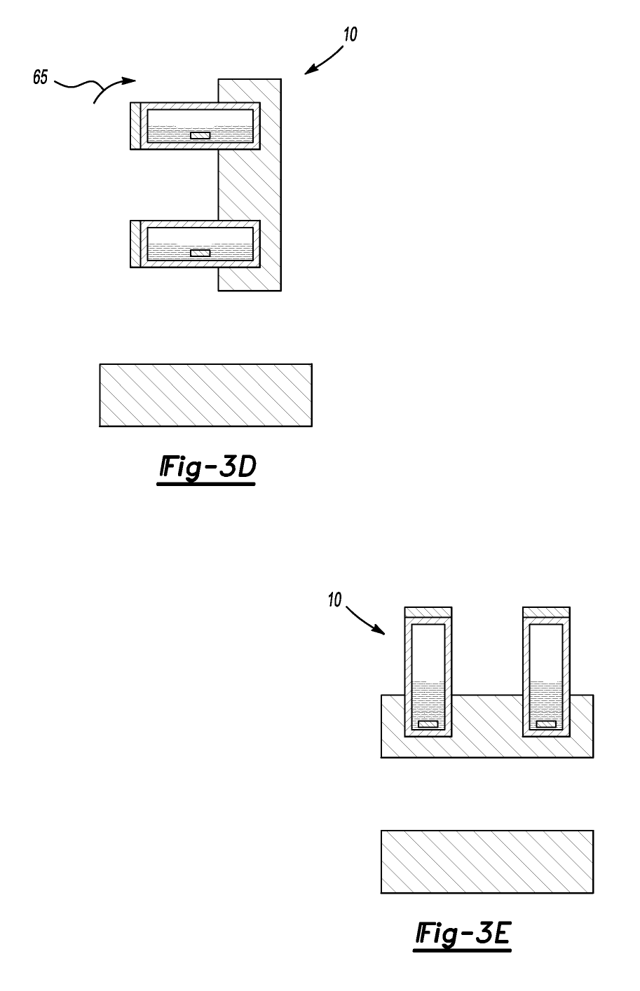

FIG. 4 shows a partial section, perspective view of another preferred embodiment of the material handling apparatus of the first embodiment, which preferred embodiment is material handling apparatus 100 (other embodiments of the material handling apparatus of the first embodiment are contemplated). Material handling apparatus 100 comprises magnetic stirrer 20, container holder 130, containers 50 having bottom portion 54 (shown by hidden line 53 for one container 50) of enclosed volumetric space 52, container sealing means 58, shaft 140, magnetic stir elements 21 (shown with hidden line), and partially open-ended cylinder 170. Also, shown in FIG. 4 for illustrative purposes are a means for rotating 60, and direction arrow 65, which indicates a possible direction of rotation of shaft 140 and, thus, of partially open-ended cylinder 170 and container holder 130, around a horizontal x-axis (see FIGS. 5A and 5B).

Magnetic stirrer 20, magnetic stir elements 21, containers 50 are the same as described previously for FIG. 1.

Container holder 130 comprises a non-magnetic material and defines container receiving apertures 134 and has long edges 135 and spaced-apart and opposing left face 131 and right face (not shown). Container holder 130 is identical to container holder 30 except container holder 130 does not define a shaft receiving aperture in its right face (not shown).

Shaft 140 has spaced-apart cylinder-receiving end (not shown) and drive element engaging end 144. Drive element engaging end 144 of shaft 140 is in driving operative connection to means for rotating 60 via projected line 62. Shaft 140 and means for rotating 60 are not drawn to the same scale.

Partially open-ended cylinder 170 defines spaced-apart inner cylindrical surface 172 and outer cylindrical surface 174 and has spaced-apart open end 171 and closed end 173. Closed end 173 is in operative connection to end cap 176. End cap 176 defines shaft receiving aperture 177. Partially open-ended cylinder 170 is characterized as having an inner diameter (not indicated) that is dimensioned so as to reversibly operatively contact, preferably via a friction fit, long edges 135 of container holder 130, thereby establishing a means for holding container holder 130 within open-ended cylinder 170, thereby being secured for rotation thereof.

Assemble material handling apparatus 100 by securely disposing holder receiving end (not shown) of shaft 140 within shaft receiving aperture 177 of end cap 176 of partially open-ended cylinder 170. Engage drive element engaging end 144 of shaft 140 in rotatable operative contact with a means for rotating 60, which also functions to hold partially open-ended cylinder 170 and shaft 140 above a supporting surface (not shown, e.g., a laboratory bench top). Insert container holder 130 into partially open-ended cylinder 170 via open-end 171 such that container holder 130 is not in operative connection to (although it may or may not be touching) either end cap 176 of partially open-ended cylinder 170 or holder receiving end (not shown) of shaft 140. Dispose magnetic stirrer 20 on a supporting surface (not shown) and below and spaced-apart from partially open-ended cylinder 170. Magnetic stirrer 20 is so disposed so as to establish magnetic field communication between the magnetic field (not shown) of driver magnet (not shown) of magnetic stirrer 20 and at least bottom portions 54 of enclosed volumetric spaces 52 of containers 50, when present, while providing sufficient space between partially open-ended cylinder 170 and magnetic stirrer 20 so as to allow partially open-ended cylinder 170 with container holder 130 disposed therein to be rotated above magnetic stirrer 20 without physically contacting magnetic stirrer 20. Thus is assembled material handling apparatus 100.

Before operating material handling apparatus 100 in the mixing method of the second embodiment, first make preparations for such mixing as described previously with the material handling apparatus 10 of FIG. 1. It is convenient to first dispose containers 50 having the flowable materials (not shown) and magnetic stir element 21 disposed therein and being in sealing operative contact with one of the container sealing means 58 (see discussion of FIG. 1) in container receiving apertures 134 of container holder 130 before disposing container holder 130 in partially open-ended cylinder 170. Thus, the material handling apparatus 100 is prepared for performing a mixing method of the second embodiment.

In some embodiments, perform the method of the second embodiment employing material handling apparatus 100 as described previously for and with material handling apparatus 10 of FIG. 1 (other ways of performing the mixing method of the second embodiment with material handling apparatus 100 are contemplated). Thus are established two simultaneous approximately orthogonal motive forces and, thus, directional movements of the flowable materials in a same container 50, thereby mixing the flowable materials together to form an approximately uniform mixture thereof in the same container 50 with material handling apparatus 100 according to the method of the second embodiment as described previously with material handling apparatus 10.

FIG. 5A shows two orthogonal force directions placed within x,y,z coordinates. In FIG. 5A, a rotating force direction 91 is shown vertically disposed in an x-y plane, a top-to-bottom linear force direction 92 is shown vertically disposed in an x-y plane, and rotating force direction 91 is shown intersecting linear force direction 92 at intersection point 93. Rotating force direction 91 is periodically approximately orthogonal to linear force direction 92, that is rotating force direction 91 is periodically approximately perpendicular (i.e., approximately 90 degrees) to linear force direction 92, e.g., at intersection point 93, periodically anti-parallel to linear force direction 92 at intersection point 94, and periodically parallel to linear force direction 92 at intersection point 95.

FIG. 5B shows two orthogonal force directions placed within x,y,z coordinates. In FIG. 5B, a rotating force direction 98 is shown horizontally disposed in an x-z plane, a top-to-bottom linear force direction 92 is shown vertically disposed in an x-y plane, and rotating force direction 98 is shown intersecting linear force direction 92 at intersection point 96. Rotating force direction 98 is essentially continuously approximately orthogonal to linear force direction 92, that is rotating force direction 98 is essentially continuously approximately perpendicular (i.e., approximately 90 degrees) to linear force direction 92, e.g., at intersection point 96.

Directionality of the two motive forces is frequently described herein with reference to being in x-y and x-z planes. The invention also contemplates the two motive forces being in any mutually orthogonal planes, including a y-z plane and tilted planes that are not strictly x-y, x-z, or y-z planes.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Summary or Detailed Description of the Invention are hereby incorporated by reference. In an event where there is a conflict between what is written in the present specification and what is written in a patent, patent application, or patent application publication, or a portion thereof that is incorporated by reference, what is written in the present specification controls.

In the present application, any lower limit of a range of numbers, or any preferred lower limit of the range, may be combined with any upper limit of the range, or any preferred upper limit of the range, to define a preferred aspect or embodiment of the range. Each range of numbers includes all numbers, both rational and irrational numbers, subsumed within that range (e.g., the range from about 1 to about 5 includes, for example, 1, 1.5, 2, 2.75, 3, 3.80, 4, and 5).

In an event where there is a conflict between a compound name and its structure, the structure controls.

In an event where there is a conflict between a unit value that is recited without parentheses, e.g., 2 inches, and a corresponding unit value that is parenthetically recited, e.g., (5 centimeters), the unit value recited without parentheses controls. As used herein, “a,” “an,” “the,” “at least one,” and “one or more” are used interchangeably. In any aspect or embodiment of the instant invention described herein, the term “about” in a phrase referring to a numerical value may be deleted from the phrase to give another aspect or embodiment of the instant invention. In the former aspects or embodiments employing the term “about,” meaning of “about” can be construed from context of its use. Preferably “about” means from 90 percent to 100 percent of the numerical value, from 100 percent to 110 percent of the numerical value, or from 90 percent to 110 percent of the numerical value. In any aspect or embodiment of the instant invention described herein, the open-ended terms “comprising,” “comprises,” and the like (which are synonymous with “including,” “having,” and “characterized by”) may be replaced by the respective partially closed phrases “consisting essentially of,” “consists essentially of,” and the like or the respective closed phrases “consisting of,” “consists of,” and the like to give another aspect or embodiment of the instant invention. In the present application, when referring to a preceding list of elements (e.g., ingredients), the phrases “mixture thereof,” “combination thereof,” and the like mean any two or more, including all, of the listed elements. The term “or” used in a listing of members, unless stated otherwise, refers to the listed members individually as well as in any combination, and supports additional embodiments reciting any one of the individual members (e.g., in an embodiment reciting the phrase “10 percent or more,” the “or” supports another embodiment reciting “10 percent” and still another embodiment reciting “more than 10 percent.”). The term “plurality” means two or more, wherein each plurality is independently selected unless indicated otherwise.

The present invention generally relates to moving or mixing flowable material(s) by simultaneously applying two approximately orthogonally-oriented motive forces to the flowable material(s) disposed in a container. The terms “two motive forces” and “two (simultaneous) approximately orthogonally-oriented motive forces” are synonymous and do not exclude applying additional motive forces (e.g., a third motive force). In some embodiments, only two motive forces are applied.

The term “approximately orthogonally” and phase “approximately perpendicularly at a point of intersection” are synonymous and mean an angle of from about 60 degrees to about 120 degrees, more preferably from about 70 degrees to about 110 degrees, still more preferably from about 80 degrees to about 100 degrees, and even more preferably from about 85 degrees to about 95 degrees (including from 86.0 degrees to 94.0 degrees).

In some aspects of the second embodiment, the two motive forces are periodically approximately orthogonal to each other. That is, sometimes the two motive forces are approximately orthogonal to each other and at other times can be approximately parallel or anti-parallel to each other. An example of said method when the two motive forces are periodically approximately orthogonal to each other is where one of the two motive forces is gravity having a downward direction (e.g., 92) along a y-axis in an x-y plane and the other of the two motive forces is a tumbling magnetic stir element rotating (e.g., in direction of arrow 91) about the z-axis in the x-y plane, the motive force directions being illustrated in FIG. 5A and described previously herein. In other aspects of the second embodiment, the two motive forces are essentially continuously approximately orthogonal to each other. An example of said method when the two motive forces are essentially continuously approximately orthogonal to each other is where one of the two motive forces is gravity (e.g., 92) having the downward direction along the y-axis in the x-y plane and the other of the two motive forces is a spinning magnetic stir element rotating (e.g., in direction of arrow 98) about a y-axis in an x-z plane, the motive force directions being illustrated in FIG. 5B and described previously herein.

Where there are two or more flowable materials disposed in the container, the present invention method provides an approximately uniform mixture thereof. The term “approximately uniform mixture” means a composition of two or more materials, the composition being at least 85 percent (%) mixed, preferably at least 95% mixed, more preferably at least 99% mixed, as determined by refractive index measurements (see Example 1 later).

In some embodiments, the means for simultaneously applying two motive forces comprises a means for producing a magnetic field, and more preferably a means for producing and moving, preferably rotating, a magnetic field and a means for rotating the container, wherein the means for producing a magnetic field or the means for producing and moving a magnetic field is disposed proximal to, but spaced apart from, the container, thereby allowing rotation thereof by the means for rotating the container; and the means for producing a magnetic field or the means for producing and moving a magnetic field is in magnetic field communication with at least a portion of the enclosed volumetric space of the container, the means for producing a magnetic field or the means for producing and moving a magnetic field and means for rotating the container being capable of producing different ones of the two motive forces. In some embodiments, the material handling apparatus further comprises a container holder disposed for holding the container, the means for producing a magnetic field or the means for producing and moving a magnetic field being disposed proximal to, but spaced apart from, the container and container holder, thereby allowing rotation of the container and container holder by the means for rotating the container.

In all embodiments, each of the two motive forces is greater than zero Newtons (i.e., greater than 0 N). The term “motive force” means a vector quantity that produces an acceleration of a material in the direction of the vector quantity's application. Examples of suitable motive forces are gravity, sound waves, and a physical power produced by, for instance, rotating a stirring element (e.g., an impeller or magnetic stir element), shaking, spinning, rocking, and vibrating (e.g., sonic vibrating). Directionality of the vector quantities of the two motive forces are regularly coordinated with respect to each other, i.e., are not random. Such directionality is periodically or essentially continuously oriented so as to systematically establish their mutually orthogonal characteristic. In some embodiments, the regular coordination is characterizable as being cyclical, rhythmic, pulsating, periodic, repetitive, ordered, or continual. Preferably, the two motive forces are different, more preferably when they are gravity and a physical power characterized by a force vector tangential to circular motion of a rotating magnetic stir element. The phrase “motive force communication” means transmission of the vector quantity from its source (i.e., portion of the means for simultaneously applying two motive forces within the enclosed volumetric space of the container) to its target (e.g., flowable material disposed in the enclosed volumetric space of the container).

In some embodiments, each of the force directions is characterized as being within a same plane (i.e., two-dimensional space), preferably a horizontal x-z plane (see FIGS. 5A and 5B). In such embodiments, the force directions would preferably be horizontally from left to right (or vice versa) along an x-axis (see FIGS. 5A and 5B) and horizontally from front to back (or vice versa) along a z-axis (see FIGS. 5A and 5B). In some embodiments, each of the force directions is characterized as being within a different plane and the plane of one of the force directions is oriented approximately orthogonally to plane of the other of the force directions. More preferably, one of the planes is oriented horizontally in an x-z direction (see FIGS. 5A and 5B) and the other of the planes is oriented vertically in an x-y direction (see FIGS. 5A and 5B).

Preferably, speed of movement of the flowable material resulting from at least one and more preferably each of the motive forces acting on the flowable material is adjustable. Ways of adjusting speed of movement of the flowable material resulting from the motive force(s) include varying a setting of the material handling apparatus of the first embodiment (e.g., varying rotation revolutions per minute (rpm)), varying an operating condition (e.g., varying temperature, pressure environment (e.g., ambient, below ambient (i.e., vacuum), or above ambient pressure), or both of the materials being mixed) during the method of mixing of the second embodiment, or both.

The “means for simultaneously applying two motive forces within the enclosed volumetric space of the container” can comprise one device capable of independently producing each of the two motive forces, but preferably it comprises two devices, each of the two devices being capable of producing, or facilitating action of, one of the two motive forces. The two devices may or may not be physically connected to each other. The phrase “facilitating action of” refers to a device that moves the container (e.g., rotates the container upside down, then right side up, and so on) so that a motive force such as gravity can act upon flowable material(s) disposed in the enclosed volumetric space of the container. An example of the device that facilitates action of gravity is the means for rotating (e.g., 60) the container. The term “means for rotating” means any device (e.g., 60) or method useful for rotating a shaft (e.g., 40 and 140), preferably a device having a variable speed control means (separate or integrated therein) for varying as desired the number of revolutions per minute of a shaft (e.g., 40) being rotated thereby. An example of such a method is a manual rotation method such as, for example, by a human being. Examples of such a device are a variable speed stirrer motor for rotating a stir shaft. Preferably, the variable speed stirrer motor is air-driven or electrically powered. Examples of suitable variable speed stirrer motors are a Servodyne mixer head/controller model 50000-01 (Cole Parmer Instruments, Vernon Hills, Ill., USA) and a ROTOMAG R-Series mini PMDC motor (Rotomag Motors & Controls Pvt. Ltd., Near Anand, Gujarat, India). The variable speed stirrer motors can be connected directly to a shaft (e.g., 40) or indirectly such as via a drive belt.

Examples of a device that is capable of producing one of the two motive forces are the “means for producing a magnetic field” and the “means for producing and moving a magnetic field.” The phrase “means for producing a magnetic field” means a device capable of creating one or more magnetic fields. Examples of a device that is the means for producing a magnetic field are a stationary magnet, a magnetic tumble stirrer, and a magnetic stir plate. When a stationary magnet (e.g., a stationary bar magnet) is employed as a device for producing one of the two motive forces, the other of the two motive forces comprises a means for periodically moving a magnetic stir element (e.g., 21) out of alignment with the magnetic field produced by the stationary magnet, and then allowing the magnetic stir element to move back into alignment with the magnetic field, thereby establishing one of the two motive forces as being a periodic magnetic motive force.

More preferred is the “means for producing and moving a magnetic field.” The phrase “means for producing and moving a magnetic field” means a device capable of creating and moving one or more magnetic fields. Examples of a device that is the means for producing moving a magnetic field are the magnetic tumble stirrer and magnetic stir plate. Examples of suitable movements of moving magnetic fields are back-and-forth and, preferably, rotating, more preferably spinning or tumbling. The device typically has one or more driver magnets (not shown) and one or more means for moving (preferably rotating) same (e.g., electric motor). In some embodiments suitable for high throughput research, the device has one driver magnet for a moving a plurality of magnetic stir elements (e.g., 21) or two or more driver magnets up to as many as one driver magnet for each magnetic stir element, the two or more driver magnets of the magnetic stirrer being spaced-apart from each other sufficiently so their magnetic fields do not unacceptably interfere with each other. The driver magnet(s) generate a magnetic field (not shown). Movement of the driver magnet(s) (not shown) by the means for moving same (not shown) causes movement of the magnetic field (not shown) produced therefrom, which results in movement (preferably rotation) of magnetic stir elements (e.g., 21) in containers (e.g., 50). Driver magnet(s) (not shown) and magnetic stir elements (e.g., 21) are different. Preferably, the means for producing and moving a magnetic field is a magnetic stirrer (e.g., 20). More preferably, the magnetic stirrer (e.g., 20) is a conventional magnetic stir plate or a magnetic tumble stirrer. The conventional magnetic stir plate preferably is for spinning magnetic stir element(s) in a horizontal x-z plane (see FIG. 5B), the conventional magnetic stir plate being, for example, a commercially available CORNING® Magnetic Stirrer available from Cole-Parmer (Vernon Hills, Ill., USA) under item number WU-84302-00. (CORNING® is of Coming Incorporated, Coming, N.Y., USA). The magnetic tumble stirrer preferably is for tumbling magnetic stir element(s) in a vertical x-y plane (see FIG. 5A), the magnetic tumble stirrer being, for example, a commercially available VP 710 series Alligator Microplate Magnetic Tumble Stirrer (U.S. Pat. No. 6,176,609; V&P Scientific, Inc., San Diego, Calif., USA).

When the invention contemplates employing a container holder (e.g., 30), preferably the container holder is capable of holding from 1 to 1000 containers, more preferably from 4 to 96 containers. The invention contemplates embodiments wherein the material handling apparatus of the first embodiment has and the method of the second embodiment simultaneously employs more than one container holder (e.g., four 96-well plates giving a total of 384 containers).

The invention contemplates other means of holding container holder 30 that do not include shaft 40 or means for rotating 60. Examples of such other means of holding are a rectangular frame on which container holder 30 could securely sit, a frame having spaced-apart opposing rails against which front and rear faces 36 and 38 (not shown) of container holder 30 could be urged, and an open-ended cylinder (see 170 in FIG. 4).

The invention contemplates employing containers (e.g., 50) for holding the flowable materials. The term “container” means a vessel defining an enclosed volumetric space. Any containers suitable for mixing can be used. In some embodiments, size of the enclosed volumetric space of the container is a volume suitable for manufacturing scale operations such as, for example, where the vessel is a 100 gallon (380 liter) to 10,000 gallon (38,000 liter) mixing or reactor vessel. In some embodiments, size of the enclosed volumetric space of the container is a volume suitable for pilot plant scale operations such as, for example, where the vessel is from 10 liter to less than 100 gallon (380 liter) mixing or reactor vessel. In some embodiments, size of the enclosed volumetric space of the container is a volume suitable for laboratory scale operations. Examples of types of suitable laboratory scale containers (e.g., 50) are vials, test tubes, mixing tubes, beakers, bottles, and 96-well plates. Volumes of the suitable laboratory containers (e.g., enclosed volumetric space 52 of containers 50) can be any volume up to about 10,000 milliliters (mL). Preferably, the volumes are 1000 mL or less, more preferably 50 mL or less, still more preferably about 20 mL or less, and at least about 0.2 mL. In some embodiments, containers having flowable materials and a magnetic stir element, if any, disposed therein also have headspaces that comprises at least 10 percent, more preferably at least 15 percent, of enclosed volumetric space (e.g., 52) of the containers (e.g., 50).

The containers can be open but preferably are sealed (e.g., stoppered or screw-capped) with a container sealing means. The term “container sealing means” refers to a device for sealing (preferably reversibly) a vessel defining an enclosed volumetric space so as to prevent fluid communication between the enclosed volumetric space of the vessel and a space exterior to the vessel. Examples of container sealing means are rubber or silicone septa; tetrafluoroethylene tape and means for securing said tape to said vessel (e.g., rubber band, wire, or adhesive tape); and, when containers comprise a vial having an externally screw-threaded open end, an internally screw-threaded vial cap.

When the invention employs in a method of the second embodiment magnetic stir element(s) disposed within the container(s) (e.g., 50), each container, and any container holder (e.g., 30) also employed, independently comprises an essentially non-magnetic material. The term “essentially non-magnetic material” means a substance that practically does not produce a magnetic field at the temperature(s) employed during the method of the second embodiment. Preferably, the substance practically does not produce a magnetic field at a temperature of 20° C. Examples of suitable essentially non-magnetic materials are glass, aluminum, ceramic, polyethylene, polypropylene, and a steel alloy having about 12% manganese.

When the invention employs magnetic stir elements, the magnet can comprise any suitable permanent magnet material and be shaped in any geometry. Examples of suitable magnetic stir elements are magnetic stir bars, dowels, discs, or spheres. Examples of suitable magnet materials for the magnetic stir elements are iron magnets and rare earth magnets (e.g., neodymium (Nd) magnets). Examples of suitable shapes of the magnetic stir elements are sphere, disc, dowel (i.e., rod), and bar (e.g., cylindrical or ovoid). When a magnetic field is rotated in the method of the second embodiment, preferably the shape of the magnetic stir element (e.g., 21) is disc, dowel, or bar. In the method of the second embodiment when a magnetic tumble stirrer is employed, disc shaped magnets are preferred.

Preferably, the method of the second embodiment employs the material handling apparatus of the first embodiment. Preferably, two or more flowable materials are disposed in the enclosed volumetric space of the container and the material handling apparatus of the first embodiment simultaneously applies each of the two motive forces to the two or more flowable materials therein, the two motive forces simultaneously moving different portions of the two or more flowable materials in two approximately orthogonal directions in the container, thereby producing an approximately uniform mixture of the two or more flowable materials. The phrase “moving different portions of a flowable material in a container in two approximately orthogonal directions” and the like mean that in a vessel some, or all, of the flowable material flows in a first direction (e.g., downward) and some other, but not all, of the flowable material flows in a second direction (e.g., sideways), the second direction of flow being approximately perpendicular to the first direction of flow. Preferably, the container is reversibly sealed with the container sealing means, and thus the two or more flowable materials are mixed in, and the mixture thereof is produced in, the container while it is so reversibly sealed.

Preferably, the material handling apparatus of the first embodiment is a high throughput material handling apparatus comprising a means for simultaneously and independently applying the two motive forces to enclosed volumetric spaces of each of a plurality of containers. More preferably, high throughput material handling apparatus is capable of mixing according to a method of the second embodiment two or more flowable materials in each of the plurality of containers, wherein the flowable materials in different ones of the containers may be the same or different. Also preferably, the method of the second embodiment comprises a high throughput mixing workflow that employs the high throughput material handling apparatus.

The term “workflow” means an integrated process comprising steps of experimental design, mixing two or more materials together to give mixtures, independently analyzing the mixtures to determine one or more characteristics or properties thereof (e.g., degree of mixing), and collecting data from the resulting mixture analyses. In this context, the term “high throughput workflow” means the steps of the workflow are integrated and time-compressed such that an overall time to execute the integrated process of the high throughput workflow is from 2.0 times or more (e.g., 10, 50 or 100 times or more) faster than an overall time to execute a corresponding process of a standard non-high throughput workflow (e.g., any corresponding prior art process). Preferably, the high throughput workflow system of the third embodiment further comprises a material dispensing robot for dispensing flowable materials, especially liquids, into the plurality of containers.

The invention contemplates some embodiments will further comprise or employ a means of varying the pressure environment, a means of heating or cooling the flowable materials, or both in the containers (e.g., 50). Examples of such means of heating are infrared radiation, microwave radiation, hot air environment, a heating bath (e.g., warm water or mineral oil bath), and, preferably, employing a container holder having a thermostatable heating element (e.g., electric heating element) disposed therein. Examples of such means for cooling are cold air environment, a cooling bath (an ice/water bath, and a container holder (e.g., 30) having a thermostatable cooling element (e.g., chilled glycol line). Preferably, the heating and cooling baths are those in which the containers can be rotated. A preferred temperature range for carrying out the method of the second embodiment is from 0° C. to 120° C. Ambient temperature (e.g., 20° C.) is preferred. When flowable materials are employed that are difficult to move or mix at ambient temperature (e.g., liquids having viscosities above 100,000 cP and preferably less than 500,000 cP, or flowable materials having densities differing by a factor of 1.5 or more), the flowable materials can be heated as described above to lower their effective viscosities.

The method of the second embodiment contemplates procedures wherein additional flowable materials are added during performance of the method.

The material handling apparatus of the present invention can be constructed from one or more materials known for use in the art. Examples of the materials are metals (e.g., titanium), metal alloys (e.g., steel, stainless steel, and HASTELLOY® (Haynes International, Inc.) alloys), glass (e.g., a borosilicate glass), ceramic, plastic (e.g., polypropylene and polytetrafluoroethylene), reinforced plastic (e.g., fiberglass reinforced plastic), and combinations thereof. Illustrative construction materials are number 316 stainless steel, borosilicate glass, and polytetrafluoroethylene. For example, shafts 40 and 140 can be made of number 316 stainless steel, container holder 30 and coatings on magnetic stir elements of polytetrafluoroethylene, containers 50 of borosilicate glass, partially open-ended cylinder 170 of aluminum, and magnetic stirrer 20 of materials found in commercially available magnetic stir plates.

The present invention contemplates employing any flowable material. The term “flowable material” means a particulate solid, liquid, or gas. Preferably, the flowable materials comprise a liquid flowable material and a solid flowable material, two or more different liquid flowable materials, or a liquid flowable material and a gaseous flowable material. The term “particulate solid” means a substance having a definite shape and volume and includes substances having amorphous, crystalline, or semicrystalline form and shapes such as, for example, flakes, plates, spheres, ovoids, square-shapes, needles, and the like. Preferred particulate solids are opacifiers or fillers (e.g., talc, silica dioxide, titanium dioxide, inorganic clays, organoclays, carbon blacks, zirconium oxide, and aluminum oxide. The term “liquid” includes neat substances and solutions of one or more solutes in one or more solvents. Preferred liquids are high viscosity liquids at 20° C. such as, for example, silicone oils, silicone greases, hydrocarbon oils and greases, solutions of hydrocarbon waxes in solvents, polymer latex dispersions in water, polymers dissolved in organic solvents, water soluble polymers (e.g., polyethylene oxide) dissolved in water, natural gums such as guar or xanthic gum; and low viscosity liquids at 20° C. such as, for example, water, organic solvents having boiling points less than 200° C. (e.g., alcohols, glycols, ketones, chlorinated solvents), amides such as dimethylformamide and N-methylpyrrolidine, ethers and cyclic ethers such as tetrahydrofuran, and aromatic solvents such as toluene and xylenes. Preferred gases are carbon dioxide and blowing agents such as fluorotrichloromethane (CFC 11), 1,1,1,3,3-pentafluoropropane, 1,1,2,2,3,3-hexafluoropropane, 1,1,1,2,3-pentafluoropropane, 1,1,1,3,3-pentafluorobutane, cyclopentene, normal-pentane, 1,1,2,2-tetrafluoroethane, 1,1,1-trifluoroethane, 1,1-difluoroethane, and 1,1-dichlorofluoroethane.

When two or more flowable materials are combined and mixed in a container according to the present invention, the flowable materials in a same container are different from each other. By “different,” what is meant is the flowable materials vary from each other by, for example, composition, phase (i.e., solid, liquid, or gas), density, purity, viscosity, or a combination of two or more thereof. Examples of combinations of two or more flowable materials are:

a combination of a polyglycol (e.g., a polyether-based or polyester-based glycol) and one or more of a liquid or a solid additive such as a rust inhibitor, antioxidant, biocide, and passivator;

a combination of water and one or more of a liquid or solid additive such as primary surfactant (e.g., a fatty acid or sulfonic acid), a non-ionic surfactant, a foaming agent (e.g., alkanolamides), rheology modifier (e.g., methylcellulose), conditioning agent (e.g., silicones and salts), preservative (e.g., antimicrobial), or a modifier (e.g., acid, base, opacifier, or scent);

a combination of two or more of a solid (e.g., pigment, inorganic clay, or tint) and a colloidal solution of latex in water, additive dissolved in a solvent wherein the additive is a surfactant, film forming agent, antifoaming agent, antimicrobial, dispersant, neutralizer, or rheology modifier;

a combination of two or more of a liquid (epoxy pre-polymer) and hardener (e.g., bisphenol A) dissolved in a solvent (e.g., acetone or toluene), and an additive (filler, opacifier, toughener, rheology modifier, accelerator (e.g., curing agent), adhesion promoter, colorant, and anti-oxidant; and.

a combination of two or more of a polyurethane pre-polymer made from an isocyanate and glycol, amine catalyst, dispersant, blowing agent, surfactant, and plasticizer.

As used herein, the term “viscosity” means dynamic viscosity at 20° C. as measured using a Brookfield CAP-2000 cone and plate viscometer (Brookfield Engineering Laboratories, Inc., Middleboro, Mass., USA) and the immediately following test method. Test method: If necessary, warm up the viscometer for about 30 minutes. Calibrate the viscometer using a viscosity standard by conventional means. Set the viscometer's temperature control, dispense a test sample onto the plate, and affix an appropriate cone (as would be known) thereto such that the affixed test sample completely covers a face of the cone and extends about 1 millimeter beyond the cone's edge. Wait about from 1 minute to 3 minutes to allow the affixed test sample to reach temperature equilibrium, then execute a viscosity measurement therewith with the cone being rotated at an appropriate rate for the cone (as would be known) and record the resulting outputted viscosity value for the test sample.

In some embodiments, the method of the second embodiment employs at least one flowable material that is a medium or high viscosity liquid or at least two flowable materials that are liquids, wherein at least one of the flowable materials is a low viscosity liquid (i.e., a liquid having a viscosity from 0.3 cP to less than 200 cP at 20° C.) and at least another one of the flowable materials is a medium viscosity liquid (i.e., a liquid having a viscosity from 200 cP to less than 20,000 cP at 20° C.) or, preferably, a high viscosity liquid (i.e., a liquid having a viscosity from 20,000 cP to 100,000 cP at 20° C.).

### Materials

### General Considerations

### Fluid 1 and Fluid 2:

Fluid 1: Dow Corning 705 silicone oil (refractive index (RI) is about 1.58; viscosity is about 200 cP at 20° C.); Dow Corning Corporation, Midland, Mich., USA.

Fluid 2: Cannon N4000 silicone oil (RI is about 1.4918; viscosity is about 17,000 cP at 20° C.); Cannon Instrument Company, State College, Penn., USA.

### Control Mixture of Fluids 1 And 2

Prepare by a non-invention process a uniform (i.e., 100% mixed) Control Mixture of Fluids 1 and 2 as follows: Mix Fluids 1 and 2 (about 18 mL total volume; mass ratio of Fluid 1 to Fluid 2 is 1:15) by conventional means on a dual axis mixer (an efficient commonly used laboratory mixer for preparing mixtures comprising a viscous material) for 1 minute at 2,000 revolutions per minute (rpm) to prepare the Control Mixture of Fluids 1 and 2. Measure the refractive index of the Control Mixture of Fluids 1 and 2 and determine it is 1.4969.

### EXAMPLE(S) OF THE PRESENT INVENTION

Non-limiting examples of the present invention are described below. In some embodiments, the present invention is as described in any one of the examples.

### Example 1

### Mixing a Low Viscosity Flowable Material (Fluid 1) and High Viscosity Flowable Material (Fluid 2) to Prepare an Approximately Uniform Mixture Thereof

Provide a material handling apparatus comprising the VP 710 series Alligator Microplate Magnetic Tumble Stirrer and the Servodyne mixer head/controller model 50000-01

Add 50 milligrams (mg) of Fluid 1 to 750 mg of Fluid 2 in a 1 mL glass vial to give an unmixed test sample therein, the vial having a headspace above the unmixed test sample. Mass ratio of Fluid 1 to Fluid 2 is 1:15. Repeat so as to prepare a duplicate unmixed test sample. Fluid 1 is denser than Fluid 2 and, thus, settles to the bottom of the vials. Add one rod-shaped magnetic stir element 21 (FIG. 4) to each vial. Seal the vials. Mix Fluids 1 and 2 therein according to the method of the second embodiment by simultaneously rotating shaft 140 of material handling apparatus 100 and magnetic stir elements 21, all of FIG. 4, as described previously, using the VP 710 series Alligator Microplate Magnetic Tumble Stirrer and the Servodyne mixer head/controller model 50000-01. Periodically (i.e., at 0 minute (i.e., just before starting mixing), 5 minutes, 10 minutes, 2 hours, and 24 hours) remove aliquot samples from material nearest the top of the vials and measure refractive index of the aliquot samples using an ATAGO® Refractometer (model RX-7000a (alpha); Atago Company, Limited, Tokyo, Japan) held at a temperature of 20° C. Accuracy for this refractometer is ±0.0001.

Analysis of aliquot samples at Time 0 minute show an average RI at Time 0 (RI⁰) of 1.4918 indicating no mixing of the samples. And for aliquot samples at Time 5 minutes, average RI at Time 5 minutes (RI⁵) is 1.4962; and for aliquot samples at Time 10 minutes, average RI at Time 10 minutes (RI¹⁰) is 1.497. Subtracting the average RI for aliquot samples at Time 0 from the RI of the Control Mixture of Fluids 1 and 2 gives a difference in RI of 0.0051. Determine percent of mixing in the aliquot samples at a given mixing time (Time) as follows:

Percent of mixing=[(RI^{Time})−(RIO)]×100/0.0051=[(RITime)−1.4918)]×100/0.0051. Thus, at Time T=5 minutes, the aliquot samples are 86% mixed (i.e., [1.4962−1.4918]×100/0.0051=[0.0044]×100/0/0051=0.44/0.0051=86%) and by Time T=10 minutes, the aliquot samples are 100% mixed (i.e., uniformly mixed).

For comparison purposes, separately repeat the procedure of Example 1 with duplicate samples except either rotate shaft 140 of material handling apparatus 100 (FIG. 4) with the Servodyne mixer head/controller model 50000-01 or tumble magnetic stir elements 21 (FIG. 4) with the VP 710 series Alligator Microplate Magnetic Tumble Stirrer, but not both. Rotation of shaft 140 alone gives 18% mixing after 24 hours and tumbling of magnetic stir elements 21 alone gives 2% mixing after 24 hours.

The material handling apparatus of the first embodiment and system of the third embodiment and method of the second embodiment are useful in any procedure, process, or method that could benefit from a simultaneous application of two orthogonally-directed motive forces to the flowable material(s). The embodiments are especially for moving a flowable material that is characterizable as having a high viscosity liquid at 20° C. (e.g., a high viscosity solution for crystallization of a solute therefrom) and mixing two or more flowable materials together, wherein at least one of the flowable materials is a liquid characterizable as having a medium or high viscosity liquid or is a particulate solid. Thus, the embodiments are useful in the aforementioned applications.

While the invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

What is claimed is:

1. A material handling apparatus comprising a container defining an enclosed volumetric space and a means for simultaneously applying two motive forces within the enclosed volumetric space of the container, wherein the means for simultaneously applying two motive forces within the enclosed volumetric space of the container is in motive force communication with the enclosed volumetric space of the container and each of the two motive forces independently is characterizable as having a force direction and the force direction of one of the two motive forces is oriented approximately orthogonally to the force direction of the other of the two motive forces.

2. The material handling apparatus as in claim 1, the material handling apparatus further comprising a container sealing means, the container sealing means being in sealing operative contact to the container so as to seal the container and thereby prevent fluid communication between the enclosed volumetric space of the container and a space outside of the container.

3. The material handling apparatus as in claim 1, wherein the means for simultaneously applying two motive forces comprises a means for producing and moving a magnetic field and a means for rotating the container, wherein the means for producing and moving a magnetic field is disposed proximal to, but spaced apart from, the container, thereby allowing rotation of the container by the means for rotating the container; and the means for producing and moving a magnetic field is in magnetic field communication with at least a portion of the enclosed volumetric space of the container, the means for producing and moving a magnetic field and means for rotating the container being capable of producing different ones of the two motive forces.

4. The material handling apparatus as in claim 2, wherein the means for simultaneously applying two motive forces comprises a means for producing and moving a magnetic field and a means for rotating the container, wherein the means for producing and moving a magnetic field is disposed proximal to, but spaced apart from, the container, thereby allowing rotation of the container by the means for rotating the container; and the means for producing and moving a magnetic field is in magnetic field communication with at least a portion of the enclosed volumetric space of the container, the means for producing and moving a magnetic field and means for rotating the container being capable of producing different ones of the two motive forces.

5. The material handling apparatus as in claim 4, the material handling apparatus further comprises a container holder disposed for holding the container, the means for producing and moving a magnetic field being disposed proximal to, but spaced apart from, the container and container holder, thereby allowing rotation of the container and container holder by the means for rotating the container.

6. The material handling apparatus as in claim 1, wherein the material handling apparatus is a high throughput material handling apparatus comprising a plurality of the containers and the means for simultaneously applying the two motive forces to the enclosed volumetric space of the container comprises a means for simultaneously applying the two motive forces to the enclosed volumetric spaces of each of the plurality of containers.

7. The material handling apparatus as in claim 5, wherein the material handling apparatus is a high throughput material handling apparatus comprising a plurality of the containers and the means for simultaneously applying the two motive forces to the enclosed volumetric space of the container comprises a means for simultaneously applying the two motive forces to the enclosed volumetric spaces of each of the plurality of containers.

8. A method of simultaneously moving different portions of a flowable material in a container in two approximately orthogonal directions, the method comprising a step of simultaneously applying two motive forces to a flowable material that is disposed in an enclosed volumetric space of a container, wherein each motive force independently is characterized as having a force direction and the force direction of one of the motive forces is oriented approximately orthogonally to the force direction of the other of the motive forces, thereby simultaneously moving different portions of the flowable material in two approximately orthogonal directions in the enclosed volumetric space of the container.

9. A method of simultaneously moving different portions of a flowable material in a container in two approximately orthogonal directions, the method employing the material handling apparatus as in claim 1 and comprising a step of simultaneously applying the two motive forces to a flowable material that is disposed in the enclosed volumetric space of the container, wherein each motive force independently is characterized as having a force direction and the force direction of one of the motive forces is oriented approximately orthogonally to the force direction of the other of the motive forces, thereby simultaneously moving different portions of the flowable material in two approximately orthogonal directions in the enclosed volumetric space of the container.

10. The method as in claim 8, wherein two or more flowable materials are disposed in the container and are mixed together by the two motive forces to give an approximately uniform mixture thereof.

11. The method as in claim 9, wherein two or more flowable materials are disposed in the container and are mixed together by the two motive forces to give an approximately uniform mixture thereof.

12. The method as in claim 11, wherein at least one of the flowable materials is a particulate solid or a first liquid characterized as having a dynamic viscosity of 20,000 centipoise or higher at 20° C.

13. The method as in claim 12, wherein at least one of the other of the flowable materials is a second liquid characterized as having a dynamic viscosity of less than 20,000 centipoise at 20° C.

14. The method as in claim 12, wherein at least one of the other of the flowable materials is a second liquid characterized as having a dynamic viscosity of less than 200 centipoise at 20° C.

15. The method as in claim 8, wherein each of the force directions is characterized as being within a different plane and the plane of one of the force directions is oriented approximately orthogonally to plane of the other of the force directions.

16. The method as in claim 9, wherein each of the force directions is characterized as being within a different plane and the plane of one of the force directions is oriented approximately orthogonally to plane of the other of the force directions.

17. A high throughput workflow system comprising the material handling apparatus as in claim 6.

18. A high throughput workflow system comprising the material handling apparatus as in claim 7.
